(19) United States
(12) Patent Application Publication
(10) Pub. No.: US 2012/0298944 A1
(43) Pub. Date: Nov. 29, 2012

(54) Fence Gate Extender

(76) Inventors: Betty T. Cain, Guffey, CO (US); Steven R. Wilson, Buena Vista, CO (US)

(21) Appl. No.: 13/114,888

(22) Filed: May 24, 2011

(51) Int. Cl. E06B 11/02

(52) U.S. Cl. 256/73

(57) ABSTRACT

A fence gate having a bottom extender section comprising a frame having vertical and horizontal interconnected structural members with a planar extender panel slidingly attached to the lower portion of the frame for movement within a plane parallel to the plane of the frame and motive means connected to the panel for moving it toward or away from the ground in order to open or close the space between the ground and the lower structural member of the gate.

### FIELD OF THE INVENTION

The present invention relates generally to fence gates.

### BACKGROUND OF THE INVENTION

Wide fence gates that span roadways in rural areas are typically constructed of metal tubing, rails or wooden beams and struts that comprise a frame and associated structural members, including a bottom horizontal member. The bottom member of the gate and its connecting braces must be located high enough off of the ground level to permit the gate to be swung freely even in the presence of deep snow. However, this necessary spacing of the lower gate member from the ground largely defeats the purpose of the gate in preventing the passage of small animals.

It is therefore the primary object of the present invention to provide a vertically movable extension for a fence gate that can be lowered to ground level to cover the area between the bottom member of the gate frame and the ground and when snow covers the ground can be raised so that the lower portion of the gate will avoid contact with the snow and permit the gate to freely swing on its hinges.

### DESCRIPTION OF THE DRAWINGS

FIG. 1 is a fragmentary perspective view of the fence gate of the present invention showing the gate extender in a raised position away from the ground level.

FIG. 2 is a front view of the fence gate of the present invention showing the gate extender in a raised position allowing for clearance of snow pack.

FIG. 3 is a front view of the fence gate of the present invention showing the gate extender in a lowered position.

### DETAILED DESCRIPTION OF PREFERRED EMBODIMENT

A fence gate 2 having the extender appliance 4 of the present invention is shown in all Figures of the drawings. The fence gate 2 comprises a frame having vertical end members 8 and 10 and horizontal structural members 12. The bottom horizontal structural frame member 12a is typically located a distance from the ground level 13 that it will clear most snow pack depths when the gate is swung on its hinges 15 to open or close the gate.

The gate extender 4 comprises a planar panel-forming lattice of horizontal stringers 18 and a plurality of vertical spaced apart stakes 20 that are attached to the stringers. The lateral terminal ends of the extender 4 are each defined by stakes 22 and 24. The terminal end stakes are slidingly disposed in channel members 27 and 29 that are attached to the vertical lateral extremities 8 and 10 of the gate frame.

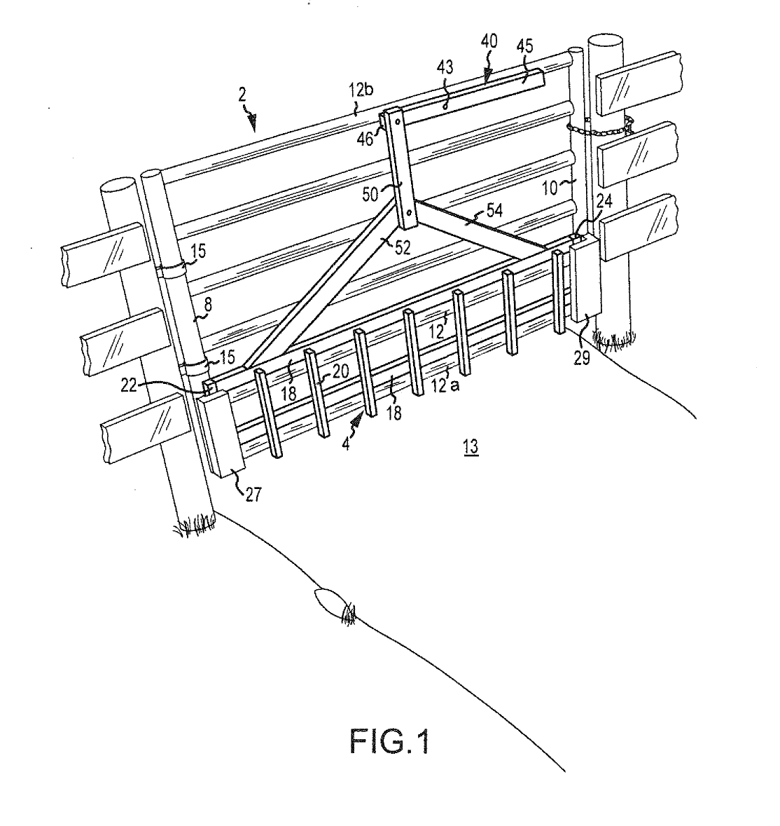

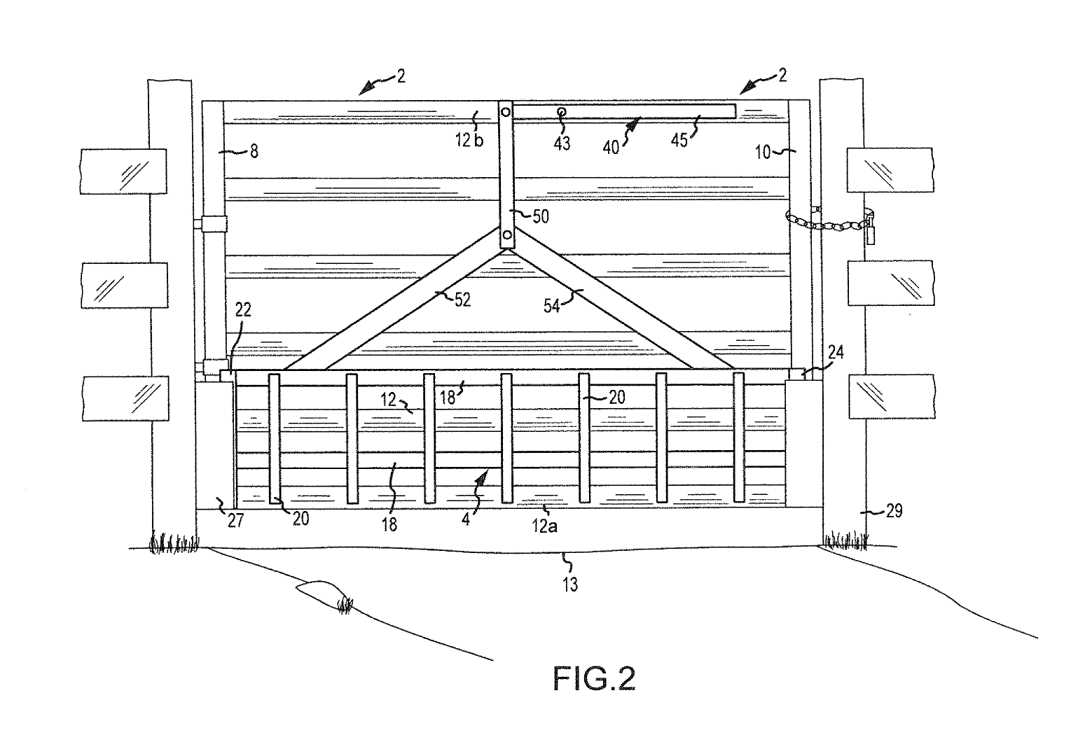

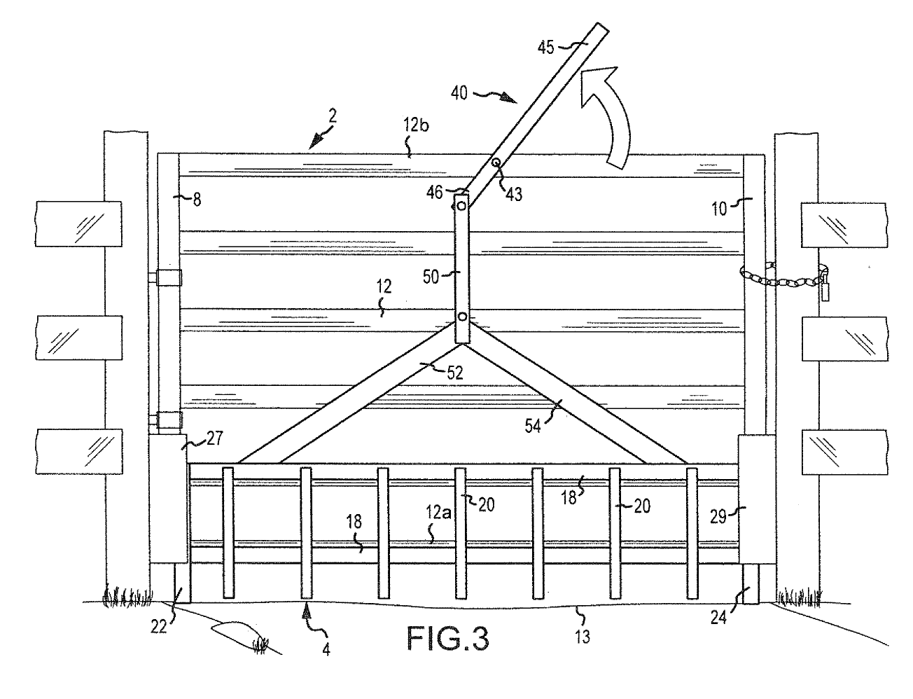

The gate extender panel 4 can be lifted upwardly to the position shown in FIG. 3 or lowered to the ground level position shown in FIGS. 1 and 2 by any number of motive devices, including a motor and gears or a more simplified mechanical structure, as shown in the drawings of the preferred embodiment of the invention.

The simplified mechanical system, as shown, comprises a lever 40 pivotally attached at a point 43 to the top horizontal beam member 12b of the gate frame. The handle portion 45 is on one end of the lever 40 and the opposing end 46 is pivotally connected to the top end of a vertically disposed lifting link 50. The bottom end of the link 50 is rigidly secured to a pair of lifting braces 52 and 54.

The mechanical operation of the linkage assembly is illustrated in FIGS. 2 and 3. FIG. 2 illustrates the lever in a horizontal position, thus raising the lifting link 50 and the extender panel 4 in order that the gate structure will clear snow on the ground.

FIG. 3 illustrates the extender panel 4 in its closed position where the handle portion 45 of the lever is used to pivot the lever upwardly which action lowers the lifting link 50 and the panel 4, allowing the panel and gate to serve their functions from the ground level up.

1-5. (canceled)

6. A fence gate comprising,
a gate supporting fence post,
a planar gate frame comprising first and second spaced apart end members, having upper and lower portions, interconnected by a plurality of horizontal members,
a plurality of hinges interconnecting the fence post and the first end member
a planar panel-forming lattice slidingly attached to the lower portions of the end members for movement within a plane parallel to the plane of the gate frame,
motive means connected to the panel-forming lattice for moving it toward or away from the upper portion of the frame.

7. The fence gate of claim 1 where the motive means comprises,
a lever pivotally connected to one of the horizontal members of the gate frame,
linkage means for moving the panel-forming lattice interconnecting the lever and the panel-forming lattice.

8. The fence gate of claim 7 where the panel-forming lattice includes,
first and second end members interconnected by a plurality of horizontally disposed stringer members,
a plurality of vertically oriented spaced apart stakes attached to the stringer members intermediate the end members.

9. The fence gate of claim 8 and further including channel forming means attached to the lower portion of each of the end members for slidingly retaining the respective ones of the end members.

10. A fence gate comprising,
a gate supporting fence post,
a planar gate frame comprising first and second spaced apart end members, having upper and lower portions, interconnected by a plurality of horizontal members,
a plurality of hinges interconnecting the fence post and the first end member,
a planar sub-panel slidingly attached to the lower portions of the end members for movement within a plane parallel to the plane of the gate frame said sub-panel comprising first and second end stakes interconnected by a plurality of horizontally disposed stringer members and a plurality of vertically oriented spaced apart stakes attached to the stringer members intermediate the end stakes, and
motive means connected to the sub-panel for moving it within its plane.
